(19) United States
(12) Patent Application Publication
(10) Pub. No.: US 2005/0246944 A1
(43) Pub. Date: Nov. 10, 2005

(54) Pest inhaler

(76) Inventor: William Thaddeus Flowers, Silver Spring, MD (US)

Correspondence Address: William Thaddeus Flowers, 13403 Guilford Run Lane # A, Silver Spring, MD, 20904, US

(21) Appl. No.: 10/839,350

(22) Filed: May 6, 2004

(51) Int. Cl. A01M 1/06; A01M 1/22

(52) U.S. Cl. 43/139; 43/112

(57) ABSTRACT

Hand-held insect exterminating device comprising: a hallow cylindrical housing including a passage therein having a forwarding disposed air inlet and an air outlet; a suction creating mechanism for drawing a stream of air, including insects entrained in the stream of air, directly into an electrically charged screen thereby killing the insects and outwardly therefrom through said outlet.

### BACKGROUND OF THE INVENTION

1. Background

The invention disclosed herein is related to insect exterminating apparatus and more particularly to a hand held insect exterminator having a vacuum unit, which will form an airstream that will rapidly carry an insect into an electrically charged screen thereby killing it.

Insects, such as wasps, cockroaches and flies are noxious pests when found in homes, outdoors, work and retail establishments. Heretofore, flies have been a particular nuisance indoors causing the use of spray products, sticky substances, swatters, rolled up newspapers, etc.

Flying insects have proven to be extremely illusive, however, a suction device with the nozzle pointed at an insect with the force to inhale it into a hot ventilated screen can cause immediate death. Portability allows the unit to be used indoors and out. Insects such as flies have been previously controlled by the use of hand-held suction devices, which trap insects. Such devices are disclosed, for example in U.S. Pat. No. 3,196,577 issued to D. M. Plunkett on Jul. 27, 1965; U.S. Pat. No. 4,074,458 issued to Richard E. Catlett on Feb. 21, 1978; and U.S. Pat. No. 4,449,319 issued to Gerry R. Garcia on May 22, 1984. Such units trap and impale the insect, but without the use of an electrically charged screen.

Accordingly, this device reduces the amount of internal mechanisms with its simplicity. Yet another object of the present invention is the removable screen that can be cleaned with use of the attached brush. Still another object of the present invention is the blow dryer type hollow housing having a ring-like columnar path of travel for directing the incoming airstream into the screen and out from the side port.

A still further object of the present invention is an electrical conduit wire when activated by pulling the trigger sends an electrical charge to heat the base thereby heating the screen that has connecting wires causing the entire screen to heat. A prior provisional application, JC139, was filed regarding the invention.

### 2. SUMMARY OF THE INVENTION

Hand-held insect exterminating device comprising: a hallow cylindrical housing including a passage therein having a forwarding disposed air inlet and an air outlet; a suction creating mechanism for drawing a stream of air, including insects entrained in the stream of air, directly into an electrically charged screen thereby killing the insects and outwardly therefrom through said outlet.

### 3. BRIEF DESCRIPTION OF THE DRAWINGS

The present invention may more readily be understood by reference to the accompanying drawing, in which:

FIG. 1 of 2 is a sectional side view, and FIG. 2 of 2 is an outside view of the unit.

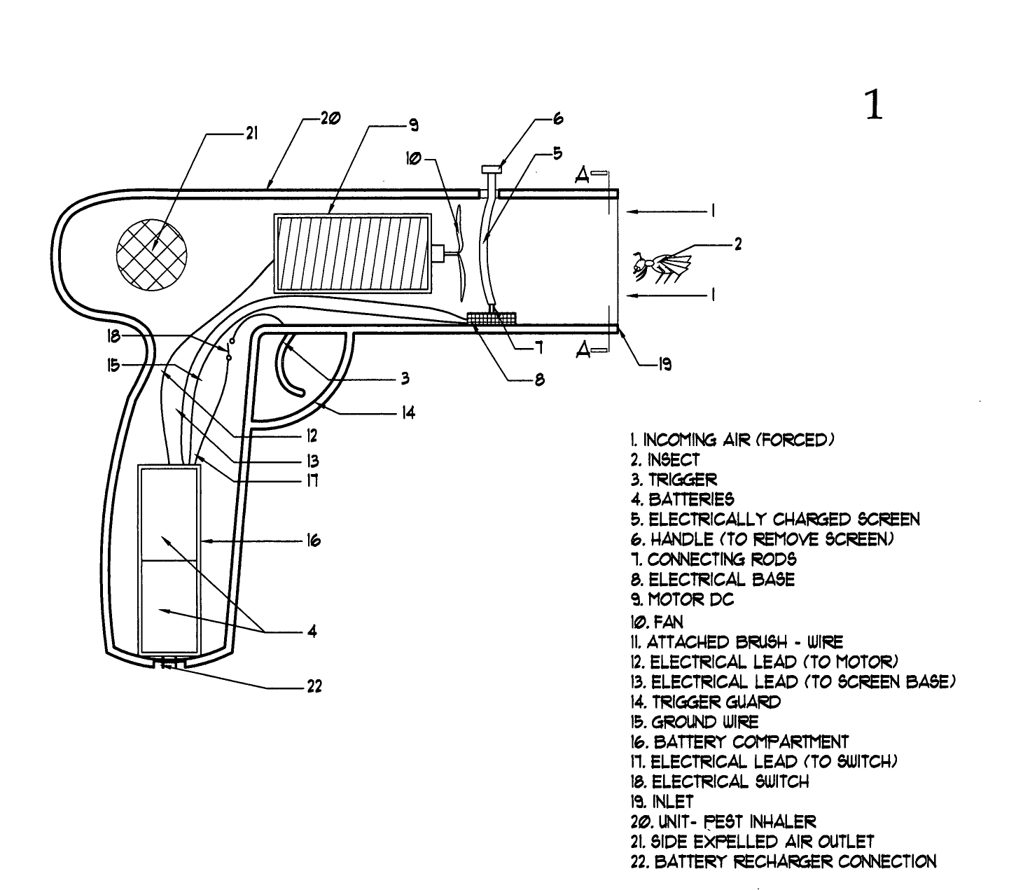

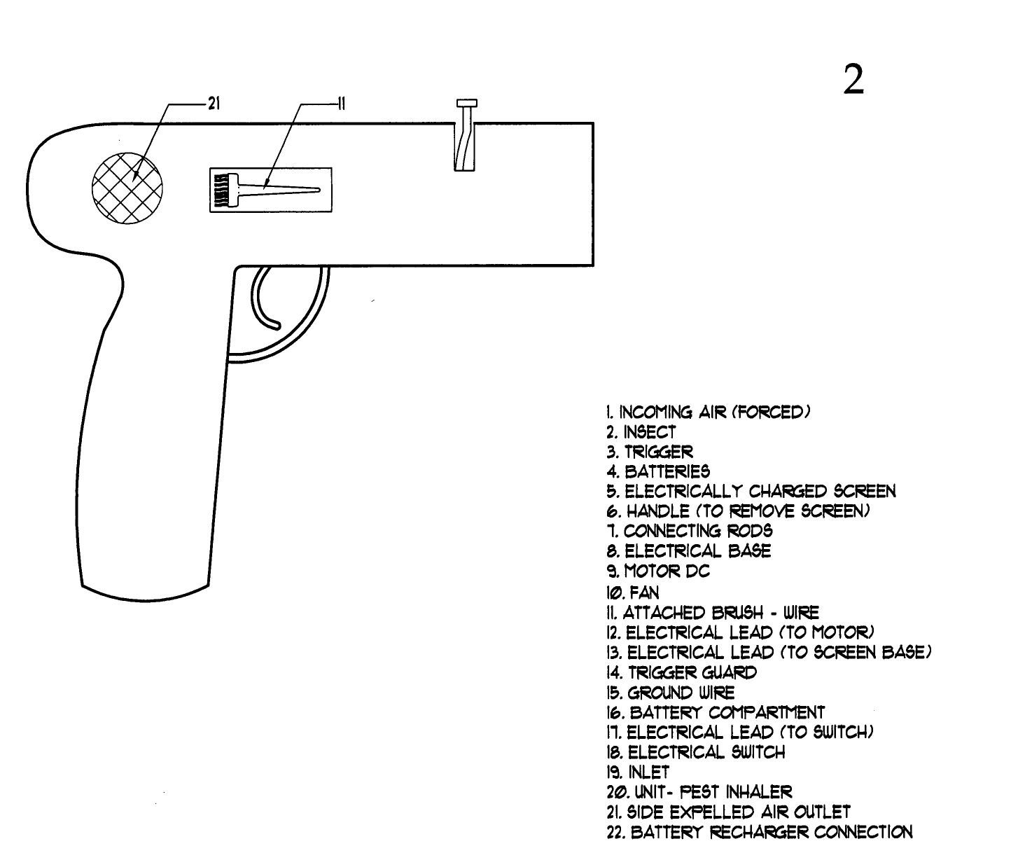

### 4. DETAILED DESCRIPTION

The user will manually grasp the unit 20, similar to grasping a blow dryer, and direct the nozzle 19 at an insect 2 to be killed. The trigger 3 is actuated to complete the circuit between the batteries 4, 4, and the seated electrical base 8, to energize the DC motor 9, which drives the fan 10 and forces air 1 outwardly of the columnar passage 21, in the direction of the arrow causing a vacuum which will draw air inwardly to the passage 1 through the inlet 19.

An electrical switch 18, normally open, is used to trigger a series relationship between the electrical components 12, 17, 13, 15, when the trigger is depressed. The vacuum created in the passage 19, will cause the insect 2 to be sucked or drawn inwardly through the inlet 19, and into the electrically charged screen 5.

The detachable screen 5 is connected to the seated electrical base unit 8, from which it draws its power. The prongs 7 provide the electrical connection to the screen that is removable by grasping the handle 6 and pulling it in an upward motion. A wire brush 11 is attached to the side of the unit for easy removal of the insects. The rechargeable batteries are encased in their compartment 16.

A rechargeable connection plate 22 at bottom of unit for use with an electrical re-charger.

1. Hand-held insect exterminating apparatus comprising: a hollow longitudinally extending housing including a passage therein having a forwardly disposed air inlet and an air outlet.

2. Suction creating means for drawing a stream of air in a downstream path of travel into said passage through said inlet and outwardly therefrom through said outlet; and insect exterminating means, disposed in the path of said stream of air; said insect exterminating means comprising an electrically charged screen for interrupting the passage of insects but including openings therethrough permitting the passage of air; said screens including a plurality of vertical and horizontal opposed electrically charged wires to trap and kill insects.

3. An insect exterminating apparatus wherein said suction creating means comprises a fan disposed in said passage and a fan driving motor mounted on a forward portion of said cylindrical member.

4. An insect exterminating apparatus wherein said housing includes a hollow handle portion, along the underside thereof, having a battery receiving receptacle therein; a battery disposed in said receptacle; circuit means for electrically coupling said motor with said battery; said circuit means includes switch means mounted on said handle for coupling said motor and said battery.

5. A side mounted attached wire brush for cleaning of removable screen.

6. A seated electrical base that connects said base to said screen by extended prongs located at base if said screen.
